(19) United States
(12) Patent Application Publication
(10) Pub. No.: US 2021/0166857 A1
(43) Pub. Date: Jun. 3, 2021

(54) ISOLATION CORE FOR POWER CONVERTER

(71) Applicant: Murata Manufacturing Co., Ltd., Nagaokakyo-shi (JP)

(72) Inventors: Scott Andrew PARISH, Milton Keynes (GB); Lee FRANCIS, Milton Keynes (GB)

(21) Appl. No.: 17/175,303

(22) Filed: Feb. 12, 2021

Related U.S. Application Data
(63) Continuation of application No. PCT/GB2019/052274, filed on Aug. 13, 2019.

(30) Foreign Application Priority Data
Aug. 13, 2018 (GB) 1813174.8

(51) Int. Cl. H01F 27/02; H01F 27/32; H01F 17/06; H01F 27/06; H01F 30/16; H01F 27/34; H01F 41/12; H02M 7/00

(52) U.S. Cl. CPC H01F 27/027; H01F 27/324; H01F 17/062; H01F 27/06; H01F 2027/065; H01F 27/346; H01F 41/125; H02M 7/003; H01F 30/16

(57) ABSTRACT

A transformer includes an isolation core casing of a power converter. The transformer includes a primary winding, a secondary winding, a magnetic core, a cover, and a cup. The cover and cup are joined and sealed together to form the core casing. The primary winding is wound directly on the magnetic core, and the magnetic core is sealed within the core casing. The secondary winding is wound around the core casing such that the primary and secondary windings are electrically isolated from each other by a solid insulation barrier provided by the core casing, resulting in no increase in the creepage or the clearance path between the primary and the secondary windings, which allows the transformer to be miniaturized without negatively affecting safety and converter performance due to leakage inductance.

### CROSS REFERENCE TO RELATED APPLICATIONS

This application claims priority to United Kingdom Patent Application No. 1813174.8 filed on Aug. 13, 2018 and is a Continuation Application of PCT Application No. PCT/GB2019/052274 filed on Aug. 13, 2019. The entire contents of each application are hereby incorporated herein by reference.

### TECHNICAL FIELD

The application relates to power converter technology, and in particular to an isolation core casing for a power converter device.

### BACKGROUND ART

Conventionally, power converters include transformers with wire windings. The windings may be wound around a magnetic core. At high voltages, it is necessary to maintain creepage and clearance distances in electric circuits between conductors, such as wire windings, for safety reasons. A creepage path is defined as the shortest path between two conductive elements, measured along the surface of any intermediate solid insulation. In other words, this is the shortest path between the primary and secondary sides of a transformer, measured along the surface of the intermediate insulation. A clearance path is defined as the shortest path between two conductive elements, measured through air. In other words, this is the shortest path between the primary and secondary sides of a transformer, measured through air. If the creepage and/or clearance distances are not adequate, an electric arc may form between conductors and jeopardise the safety of the transformer and its user. The maximum voltage of power converters is therefore limited according to maintaining an adequate creepage and clearance distance between conductors.

In the field of modern electronics, electrical devices have become smaller. This presents a challenge to manufacturers that must comply with safety limits regarding creepage and clearance distances.

At high voltages, it may be necessary to maintain a large creepage and clearance distance. However, large distances between windings and the magnetic core can increase leakage inductance from the magnetic core, which can cause problems with power converters.

We have therefore appreciated that it would be desirable to provide an isolation core casing for a power converter, which allows for miniaturization of the converter without compromising on safety and converter performance due to leakage inductance.

### SUMMARY OF THE INVENTION

According to a preferred embodiment of the present invention, a transformer for a power converter device includes a first winding that includes electrically conductive material, a second winding that includes electrically conductive material, a core, and a solid electrical insulator that includes a sealed interior space in which the core and the first winding are housed. The first winding is wound directly on the core, and the second winding is wound on an exterior surface of the solid electrical insulator such that the solid electrical insulator provides a physical barrier between the first winding and the second winding.

The solid electrical insulator can include at least one protrusion on the exterior surface of the solid electrical insulator, and the at least one protrusion can provide at least one of a physical barrier between a circuit board on which the transformer is mounted and the transformer and a separation distance between the transformer and the circuit board. The at least one protrusion can perform at least one of securing a position of the second winding exterior to the solid electrical insulator and connecting to the circuit board.

A shape of the solid electrical insulator can correspond to a shape of the core, and the solid electrical insulator can receive and can house the core and the first winding within the sealed interior space of the solid electrical insulator. A thickness of the solid electrical insulator can be within a range of 0.4 mm to 1 mm, the thickness can be defined as a distance from the exterior surface of the solid electrical insulator to a nearest point on an interior surface of the solid electrical insulator, and the interior surface of the solid electrical insulator can define the sealed interior space of the solid electrical insulator.

The solid electrical insulator can includes at least two separate portions, and the at least two separate portions can be joined and sealed together to define the solid electrical insulator including the sealed interior space of the solid electrical insulator. The at least two separate portions can be joined and can be sealed by an ultrasonically welded portion. The at least two separate portions can include a cup and a cover, the cup can include at least one surface wall that defines the sealed interior space of the solid electrical insulator and a first opening, and the cover can include at least one surface wall overlaying the first opening of the cup. A shape of the cup can defined by an inner tube and an outer tube; the inner and the outer tubes can be arranged as two concentric substantially cylindrical tubes; the inner tube can be joined to the outer tube by an annular surface that joins an outside circumference of the inner tube with an inside circumference of the outer tube, at a corresponding end of the inner and the outer tubes; the first opening of the cup can be located at opposing ends of the inner and outer tubes in an absence of a second annular surface; and a shape of the cover can be an annular surface configured to fit the first opening of the cup.

The solid electrical insulator can further include a second opening that connects the exterior surface of the solid electrical insulator with the sealed interior space of the solid electrical insulator, and the second opening can receive potting material to the sealed interior space of the solid electrical insulator and can allow air to travel from the sealed interior space of the solid electrical insulator to the exterior surface of the solid electrical insulator. The first winding can be fed through the second opening. The transformer can further include potting material disposed within the sealed interior space of the solid electrical insulator. The second opening can be sealed by the potting material.

The core can be magnetic. The core can be toroidal. The power converter device can be an AC-DC converter or a DC-DC converter. The transformer can further include at least one additional winding wound directly on the core and housed within the solid electrical insulator. The transformer can further include at least one additional winding wound on the exterior surface of the solid electrical insulator. The first winding can a primary winding, and the second winding can be a secondary winding. Or the first winding can a secondary winding, and the second winding can be a primary winding.

According to a preferred embodiment of the present invention, a method of manufacturing or assembling a transformer includes winding a first winding of electrically conductive material directly around a core, positioning and housing the core within an interior space of a sealed solid electrical insulator, and winding a second winding of electrically conductive material around an exterior surface of the sealed solid electrical insulator. The first winding is electrically insulated from the secondary winding by a physical barrier provided by the sealed solid electrical insulator.

The method can further include sealing the sealed solid electrical insulator using ultrasonic welding. The method can further include disposing potting material in the interior space of the sealed solid electrical insulator after the positioning and housing the core within the interior space of the sealed solid electrical insulator.

The sealed solid electrical insulator can includes at least one protrusion on the exterior surface of the sealed solid electrical insulator, and the at least one protrusion can provide at least one of a physical barrier between a circuit board on which the transformer is mounted and the transformer and a separation distance between the transformer and the circuit board. The at least one protrusion performs at least one of securing a position of the second winding exterior to the sealed solid electrical insulator and connecting to the circuit board.

### BRIEF DESCRIPTION OF THE DRAWINGS

FIG. 1 is an example of a toroidal transformer of an isolated power converter.

FIG. 2 is a diagram of an isolation core casing for a power converter according to a first preferred embodiment of the present invention.

FIG. 3 is a cross-sectional diagram of the isolation core casing for a power converter shown in FIG. 2.

FIG. 4 is an elevational diagram of the isolation core casing shown in FIG. 2, without the cover present.

FIG. 5 is a diagram of an isolation core casing for a power converter according to an alternative preferred embodiment of the present invention.

FIG. 6 is a diagram of the isolation core according to FIG. 5, attached to a printed circuit board.

### DETAILED DESCRIPTION OF THE PREFERRED EMBODIMENTS

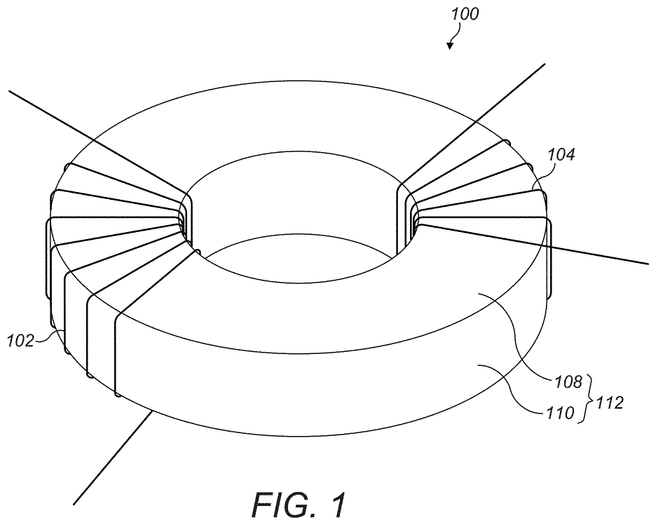

A first example of a known power converter including a toroidal transformer is described here with reference to FIG. 1.

Toroidal transformer 100 includes primary winding 102, secondary winding 104, core cover 108 and core cup 110. These components are arranged as shown in FIG. 1. The toroidal transformer also includes a toroidal magnetic core, which is not shown in FIG. 1. The magnetic core is enclosed between cover 108 and cup 110. The cover 108 and the cup 110 define a toroidal casing 112 for the core. Primary winding 102 and the secondary winding 104 are wound around the exterior of the casing 112. The position of the primary winding 102 on the casing 112 is different from the position of the secondary winding on the casing 112. In other words, the primary winding 102 and the secondary winding 104 are spatially separated.

The casing 112 includes the cover 108 and the cup 110. The cover 108 and the cup 110 are not perfectly joined. This means that there is a creepage path from the first winding 102, to the magnetic core, and then to secondary winding 104.

Consequently, the size and configuration of the toroidal transformer 100 is limited by safety requirements. In particular, a minimum creepage distance must be observed, meaning the primary winding 102, the secondary winding 104 and the magnetic core, cannot form a creepage path that is lower than the minimum creepage distance. The minimum creepage distance required for power converters usually depends on the Root Mean Square (RMS) working voltage of the converter device applied across the isolation barrier. Generally, for higher voltages, a larger minimum creepage distance must be observed.

In operation of the power converter including the toroidal transformer 100, one of the primary winding 102 and secondary winding 104 is energized. Taking the primary winding 102 as an example, the energized primary winding 102 induces a magnetic field around the magnetic core. The magnetic field around the magnetic core in turn induces an emf, or voltage, in the secondary winding 104 due to the process of electromagnetic induction. By varying the current in the primary winding 102, the magnetic flux of the magnetic field varies, which in turn induces the emf, or voltage, in the secondary winding 104. If the secondary winding is connected to a complete circuit, then current will flow through the secondary winding 104 and the attached circuit.

Since a minimum creepage and clearance distance needs to be observed between the primary winding 102 and the magnetic core, and the secondary winding 104, the toroidal transformer 100 may experience increased leakage inductance during operation, and irregularities in the induced emf, or voltage, in the secondary winding 104. This can have adverse effects and can cause problems within the power converter.

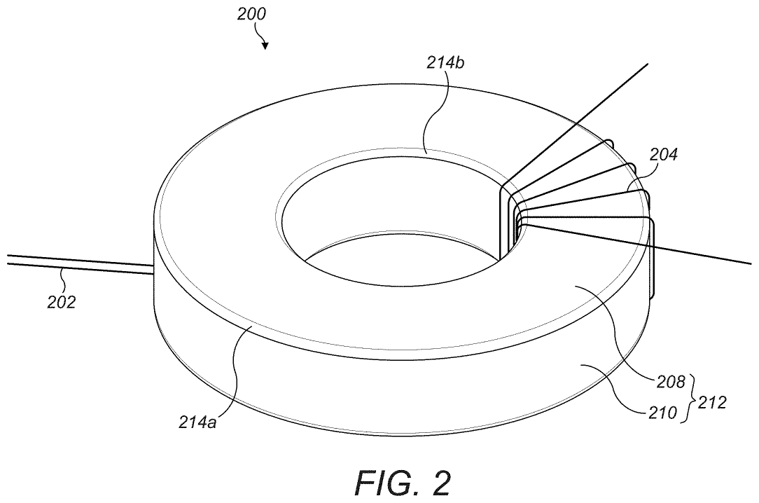

A first preferred embodiment of the present invention will now be described with reference to FIGS. 2 to 4, and its benefits over the known power converter of FIG. 1 will be discussed.

FIG. 2 shows a transformer including an isolation core casing for a power converter according to a preferred embodiment of the present invention. A transformer 200 includes a primary winding 202, a secondary winding 204, a concealed magnetic core 206 and core casing 212. The core casing 212 includes a cover 208 and a cup 210. The cover 208 and the cup 210 are joined together by seams or joins 214a and 214b.

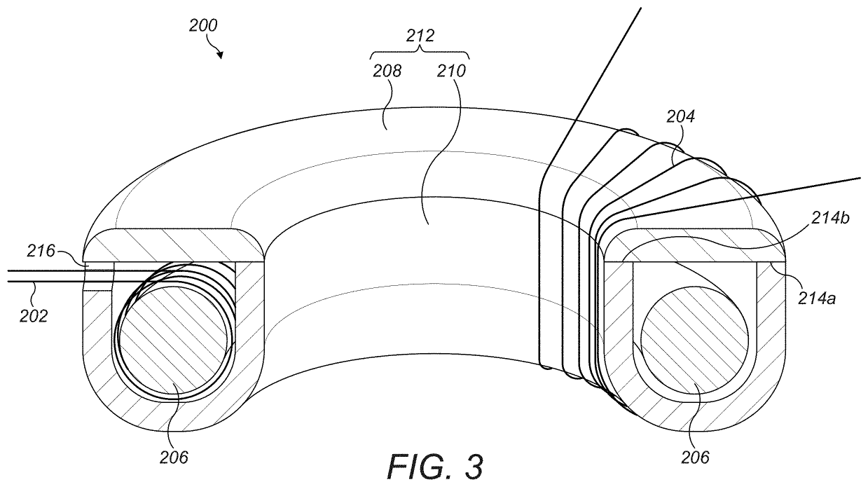

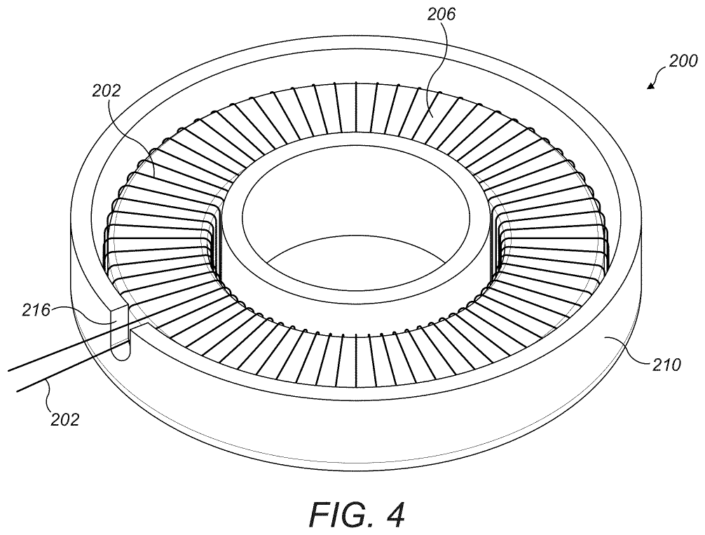

As can be seen from FIGS. 3 and 4, the magnetic core 206 is positioned and housed within an interior space of the core casing 212. The interior space of the core casing 212 is defined by the space within the joined cover 208 and the cup 210. The cup 210 has an interior space defined by an opening at one end of the cup 210, a bottom or base of the cup 210 at the other end, and the interior surface walls of the cup 210. The size and shape of the interior space of the cup 210 substantially corresponds to the size and shape of the magnetic core 206. In FIG. 2, the shape of the magnetic core 206 and the cup 210 is toroidal, but it may be other shapes in other preferred embodiments of the present invention.

The primary winding 202 is wound around the magnetic core, such that the primary winding 202 is also positioned and housed within the interior space of the cup 210. The arrangement of the primary winding 202 and the magnetic core 206 within the interior space of the cup is visible in FIG. 4.

With the primary winding 202 wound around a portion of the magnetic core 206, and the magnetic core 206 positioned within the interior space of the cup 210, the cover 208 is positioned so as to overlay the opening of the cup 210, and enclose the interior space. The cover 208 and cup 210 are then sealed to form the core casing 212. The cover 208 and cup 210 are preferably sealed using ultrasonic welding. The cover 208 seals the opening of the cup 210, such that the interior space of the cup 210 is sealed from the exterior of the cup 210. The seal or join between the cover 208 and the cup 210 form a solid bonded joint.

Once the cover 208 is joined to the cup 210, the interior space of the cup 210 becomes the interior space of the core casing 212. The interior space of the core casing 212 is defined as the space between the interior surface walls of the cup 210 and the cover 208. The magnetic core 206 and the primary winding 202 are contained and sealed within the interior space of the core casing 212.

The primary winding 202 is fed out of the interior space of the sealed core casing 212 to the exterior of the core casing 212 through an outlet portion 216. The outlet portion 216 is visible in FIGS. 3 and 4.

The secondary winding 204 is wound around the exterior surface of core casing 212, such that the primary winding 202 and the secondary winding 204 are physically separated by the core casing 212. In this way, the core casing 212 provides a solid insulating barrier between the primary winding 202 and the secondary winding 204.

The safety distance requirements with regard to a solid barrier of suitable insulating material are less than the distance requirements for creepage and clearance as discussed with reference to FIG. 1.

Therefore, the isolation cores of the preferred embodiments of the present invention are not constrained by a minimum creepage or clearance distance. Consequently, a power converter device including the isolation cores according to the preferred embodiments of the present invention can be miniaturized. In other words, the preferred embodiments of the present invention can be made smaller than the toroidal core of FIG. 1 whilst still satisfying safety requirements. For example, the thickness of the surfaces of the core casing may be 0.4 mm, which is not possible when creepage and clearance paths exist.

There are several benefits of having a solid insulating barrier between the primary winding 202 and secondary winding 204, such that creepage and clearance paths are negated. Not only can the power converter device including the isolation core according to FIG. 2 be miniaturized, but the primary winding 202 can be disposed directly on the magnetic core 206, and the secondary winding 204 can be brought, in terms of absolute distance, closer to the magnetic core 206. This reduces the leakage inductance of the magnetic core 206, without unsafely increasing the risk of electrical arcing. Therefore, transformer function and efficiency is increased by this arrangement.

The components of the preferred embodiments of the present invention according to FIGS. 2 to 4 will now be discussed in more detail.

Firstly the core casing 212, including the cover 208 and the cup 210, will be discussed.

The core casing 212, including the cover 208 and the cup 210, is formed of material suitable for electrical insulation, such as plastic, resin, rubber or the like. The core casing 112 is substantially hollow, and is defined by the sealed combination of the cup 210 and the cover 208.

The cup 210 is defined by a plurality of surface walls and an opening for receiving the magnetic core. In FIGS. 2 to 4, the cup 210 is formed in a hollow toroidal shape including an opening for receiving the magnetic core 206. The cup 210 is a similar shape to the magnetic core 206. The physical dimensions of the cup 210 are suitable for receiving and housing the magnetic core 206.

It is to be understood that the shape of the cup 210 is not limited to being a toroid. The shape of the cup 210 substantially matches the shape of the magnetic core 206. As such, the cup 210 can be cuboidal, cylindrical or any other three dimensional shape.

The volume of the interior space within the opening of the cup 210 is equal or marginally greater than the volume of the magnetic core 206 and the primary winding 202 combined. Optionally, when the magnetic core and primary winding 202 are disposed within the cup 210, most of the available space within the cup 201 is occupied by the magnetic core 206 and primary winding 202. In other words, the magnetic core 206 and primary winding 202 are secured by the interior surface walls of the cup 210 when they are disposed within the cup 210. This can be seen in FIG. 4.

On the other hand, the volume of the interior space within the opening of the cup 210 may be larger than the magnetic core 206 and the primary winding 202, such that the interior surface walls of the cup 210 do not secure the position of the magnetic core 206 and primary winding 202 within the cup 210. In this case, there is available space in the opening of the cup once the magnetic core 206 and primary winding 202 are disposed within the cup 210.

Optionally, the surface walls that define the cup 210 are thin. For example, the thickness of the surface walls may be within the range of 0.4 to 1 mm. Preferably, the thickness of the surface walls of the cup 210 are 0.4 mm. However, it is to be understood that other thicknesses may be used depending on the intended purpose of the device.

In this way the distance from the secondary winding 204 to the magnetic core 206 and primary coil 202 is minimized, so core leakage inductance can be decreased. Furthermore, a low excess volume of the cup 210 means that there is less chance of air or contaminants such as dust particles from entering and/or settling within the cup 210. Further still, the low excess volume of the cup 210 means that there is little room for movement of the magnetic core 206 or primary coil 202 within the cup 210. These effects can help to improve the life and reduce the need for maintenance of the transformer.

The cover 208 is defined by at least one surface wall. The cover 208 if formed of electrically insulating material that is similar or preferably the same material as the material that forms the cup 210. The cover 208 is substantially the same size and shape as the opening of the cup 210. In FIG. 2, the cover 208 has a substantially annular shape, defined by a larger outer circular perimeter and a smaller inner circular perimeter. The shape of the cover 208 thus matches the shape of the opening of the cup 210.

It is to be understood that the shape of the cover 208 is not limited to the annular shape shown in FIG. 2. The shape of the cover 208 substantially matches the shape of the opening of the cup 210. As such, the cover 208 can be circular, hemispherical, rectangular or any other polygon.

The cover 208 fits snugly on the magnetic core 206 and primary winding 202 contained within the cup 210. In other words, the magnetic core 206 and primary winding 202 are physically secured by the cup 210 and cover 208 such that there should be substantially no freedom for movement of the magnetic core or primary winding 202.

The at least one surface wall that defines the cover 208 is thin. For example, the thickness of the surface wall may be in the range of 0.4 to 1 mm. Preferably, the thickness of the surface wall of the cover 208 is 0.4 mm and is the same thickness as the surface walls of the cup 210. However, it is to be understood that other thicknesses may be used depending on intended use.

In this way the distance from the secondary winding 204 to the magnetic core 206 and the primary coil 202 is minimized, so core leakage inductance can be kept at a minimum. Furthermore, a low excess volume of the core casing 212 means that there is less chance of air or contaminants such as dust particles from entering and/or settling within the core casing 212. This can help to improve the life and maintenance of the transformer.

When the cup 210 contains the magnetic core 206 and the primary winding 202, the cover 208 is joined with the cup 208 to form the sealed core casing 212. The core casing 212 includes the interior space defined by the interior surface walls of the cup 210 and cover 208. The core casing 212 is formed of electrically insulating material. The core casing 212 is sealed, such that the interior of the core casing 212 and the exterior of the core casing 212 are electrically insulated from each other. The core casing 212 has a high resistivity and there is therefore a low chance of electrical discharge through the core casing 212.

The shape and volume of the interior space of the core casing 212 is similar to the shape and volume of the magnetic core 206 and the primary winding 202. This allows the magnetic core 206 and primary winding 202 to fit snugly within the core casing 212.

Alternatively, the core casing 212 may include two opposing cups 210. In this case, the cups 210 may each receive a portion of the magnetic core and primary winding 202. The join between the cups 210 is located along the perimeter edge of each rim of the opening portions of the cups 210. The cups 210 oppose each other, such that each cup 210 houses an opposite portion of the magnetic core.

The core casing 212 further includes an outlet portion 216, as shown in FIGS. 3 and 4, for allowing the primary winding 202 to connect to circuitry that is external to the transformer. The outlet portion 216 may be included in either of the cover 208, the cup 210, or both. The outlet portion 216 includes a through-hole, vent, groove or the like, for the passage of wire between the exterior and interior of the core casing 212. Wire or other suitable electrical connecting elements may then be connected to the primary winding 202 within the core casing 212 through the outlet portion 216, so that the primary winding 202 can be electrically connected to circuitry external to the core casing 212. The wiring connected to, or including the primary winding 202 can therefore be fed out of the interior space of the core casing 212 via the outlet portion 216.

The outlet portion 216 also functions as a vent or entry point for injecting potting material and allowing the exit of air during the process of injecting potting material. The process of injecting potting material into the core casing 212 is a void-free potting process. The void-free potting process ensures that the interior space of the core casing 212 is not contaminated with air pockets or dust particles, and helps to fix components, such as the magnetic core 206 and the primary winding 202, in place such that they do not move. In particular, there may be available space not occupied by the magnetic core 206 within the interior space of the core casing 212. This available space may be the result of the magnetic core 206 and the core casing 212 not being similar shapes. In this case, the remaining available space may be filled with potting using a void-free potting process, in order to structurally fix the arrangement of components of the isolation core in position.

The void-free potting process preferably occurs during manufacture of the transformer 200 or otherwise before use of the transformer 200. The void-free potting process may is performed to remove air pockets from the interior space of the core casing 212 and fix components such as the magnetic core 206 and the primary winding 202, as discussed above. During the void-free potting process, potting material is injected in a substantially liquid form through the outlet portion 216 and into the interior space of the core casing 212. The potting material may be a thermosetting plastic, or thermoplastic, a silicone rubber gel or the like. As the potting material is injected through the outlet portion 216, air from within the interior space of the core casing 212 is ejected through the outlet portion 216. The potting material then solidifies to form a solid void-free potting. The solid void-free potting is an insulator and therefore insulates the interior space of the core casing 212 from the exterior of the core casing 212 at the position of the outlet portion 216.

It is to be understood that the outlet portion 216 is therefore insulated such that a creepage or clearance path does not exist from the interior space of the core casing 212 to the exterior of the core casing 212.

The benefits of the void-free potting therefore include physically fixing and securing the components within the interior space of the core casing 212, removing the air and likelihood contamination from dust or the like within the interior space of the core casing 212, and providing electrical insulation from the interior of the core casing 212 to the exterior of the core casing 212. These benefits mean that the transformer 200 may have an improved or longer service life.

Although the outlet portion 216 is illustrated as a relatively small hole on the outer rim of the cup 210 in FIGS. 3 and 4, it is to be understood that the outlet portion may be positioned and sized differently. For example, the outlet portion 216 may be large and/or positioned on the inner surface of the cup 210, the cover 208 or both. Furthermore, the transformer 200 may include multiple outlet portions 216 such that the potting process can be expedited.

The outlet portion 216 further allows potting material to be disposed within the interior of the core casing 212 once the cover 208 and cup 210 are joined. Disposing potting material or any other filler in through the outlet portion 216, rather than through the opening of the cup before the core casing 212 is sealed and formed, is beneficial in that less contaminants and air pockets are likely to be present in the interior of the core casing 212. Furthermore, the outlet portion 216 allows air to exit the interior of the core casing 212 during the potting or filling process, such that the likelihood of air being trapped within the interior of the core casing 212, and forming air pockets, is reduced.

Given that the core casing 212 is sealed to provide a solid insulating barrier between the primary winding 202 and the secondary winding 204, it is to be understood that the outlet portion 216 is also sealed and insulated to form a solid insulating barrier. The sealing of the outlet portion 216 may be provided by a filling material, but may also be sealed by additional insulating material that covers the outlet portion 216.

Optionally, the outlet portion 216 is not sealed and insulated to form a solid insulating barrier. In this case, a creepage and/or clearance path may exist from the exterior of the core casing 212 into the interior of the core casing 212. It is therefore necessary to position the secondary winding 204 on the core casing 212 such that the creepage distance between the primary winding 202 and the secondary winding 204 is greater than the minimum creepage distance required by safety requirements.

The joins 214a and 214b that join the cup 210 with the cover 208 to form the sealed core casing 212 will now be discussed in more detail. The joins 214a and 214b are situated between the cover 208 and the opening of the cup 210. In FIGS. 2 and 3, the join 214a is located on the outer rim of the cup 210 and the join 214b is located on the inner rim of the cup 210. It is to be understood that the positions of the joins 214a and 214b may be different for different shapes of cups 210 and covers 208, in different preferred embodiments of the present invention. In particular, the position of the join depends on the dimensions of the cup 210 and the cover 208.

In FIGS. 2 and 3, joins 214a and 214b extend around the entire circumference of the outer and inner rims of the cup 210 respectively, such that they seal the cup 210 and the cover 208 together. The joins 214a and 214b are preferably ultrasonically welded such that the cover 208 and cup 210 are solidly welded to form an insulating barrier between the interior space of the core casing 212 and the exterior of the core casing 212.

However, it is to be understood that the method of joining may alternatively be injection welding, laser welding or the like. The purpose and requirement of the joins 214a and 214b is to physically and solidly seal the cover 208 to the cup 210 to form the core casing 212, such that there is a solid insulating barrier between the interior of the core casing 212 and the exterior of the core casing 212.

The magnetic core 206 will now be discussed in more detail. The magnetic core 206 is made of a suitable magnetic material. Suitable materials that can be used as the magnetic core 206 include solid metals, powdered metals, ferrite ceramics and the like. Elements or compounds that can be used as the magnetic core 206 include solid iron, carbonyl iron, silicon steel, amorphous steel, and ferrite compounds. The core 206 may be laminated. Furthermore, the core 206 may be an air core, such that it includes non-magnetic material. Materials that can be used as an air core include plastic and ceramics for example. Air cores generally have a much lower inductance but are less prone to core losses than traditional magnetic cores.

The magnetic core 206 is toroidal in FIGS. 2 to 4. However, it is to be understood that the magnetic core 206 can be any shape suitable for functioning as a transformer core, such as a cylinder, cuboid or the like. Further known shapes for the magnetic core 206 include ‘C’, ‘U’, and ‘E’ shaped cores, pot cores, and ring or bead cores. The core casing 212 may be made to fit around the desired shape of magnetic core 206.

The primary winding 202 and secondary winding 204 will now be discussed in more detail.

The primary winding 202 and secondary winding 204 are three dimensional spiral windings or planar windings. Three dimensional spiral windings are physically wound around a magnetic core. In FIGS. 2 to 4, the secondary winding 204 is an example of a three dimensional spiral winding. The primary winding 202 is also an example of a three dimensional spiral winding. The primary winding 202 is wound around the magnetic core 206 and the secondary winding 204 is wound around core casing 212. However, it is to be understood that the choice of which winding is the primary winding 202 and which winding is the secondary winding 204 is arbitrary, meaning the secondary winding 204 could be wound around the magnetic core 206 and the primary winding 202 could be wound around the core casing 212.

The primary winding 202 and secondary winding 204 are formed of electrically conductive material, such as copper, aluminium or the like. The conductive material is drawn out in a wire. The wire may have substantial insulation, such as a conformal coating, or a plastic or rubber coating. On the other hand, the wire may be enamelled or magnet wire, or may have minimal or no insulation.

In FIGS. 2 to 4, the primary winding 202 is disposed directly on the magnetic core 206. In this way, the distance between the primary winding 202 and the magnetic core 206 is minimized and as a result leakage inductance is reduced. The primary winding 202 and the magnetic core 206 have the same electrical potential when in operation, and as such, a minimum creepage path distance and minimum clearance path distance are not required. Thus, the primary winding 202 and the magnetic core 206 function correctly and effectively when the primary winding 202 is directly wound on the magnetic core 206.

In FIGS. 2 to 4, the secondary winding 204 is disposed directly on the exterior surface of the core casing 212. Thus, the distance between the secondary winding 204 and the magnetic core 206 is also minimized to reduce leakage inductance. The core casing 212 acts as a solid insulating barrier between the secondary winding 204 and the magnetic core 206.

The primary winding 202 may be wound around the entirety of the magnetic core 206, as illustrated in FIG. 4, or may be wound around a portion of the magnetic core 206. Similarly, the secondary winding 204 may be wound around the entirety of the core casing 212, or may be wound around a portion of the core casing 212.

Alternatively, the primary winding 202 and the secondary winding 204 may be planar windings. Planar windings are wound around a magnetic core, but are substantially flat, such that each winding is located on a two dimensional plane.

In this example, the magnetic core 206 may be cylindrical, an E-type core or any other shaped core suitable for electromagnetic induction using planar windings. For a cylindrical core, each of the primary winding 202 and the secondary winding 204 may be disc-shaped, with an opening for receiving the core in the centre of the disc. For an E-type core, the windings may be rectangular, with an opening in the centre of the rectangle for receiving the middle protrusion of the ‘E’ shape of the core 206.

As can be seen in FIG. 4, the magnetic core 206 occupies the majority of the interior space of the cup 210. However, it is to be understood that the magnetic core 206 may not occupy all of the interior space of the cup 210 and therefore may be smaller in comparison to the interior space of the cup 210. In this case, the magnetic core 206 can be structurally fixed in position relative to the cup 210 by implementing the void-free potting process, whereby potting material is injected into the cup 210 as discussed previously.

Alternative preferred embodiments of the present invention will now be described. It is to be understood that the features described here with reference to alternative preferred embodiments of the present invention can be substituted with similar features of the other preferred embodiments of the present invention. Furthermore, features described here which have no similar feature according to the alternative preferred embodiments of the present invention may be added to the other preferred embodiments of the present invention.

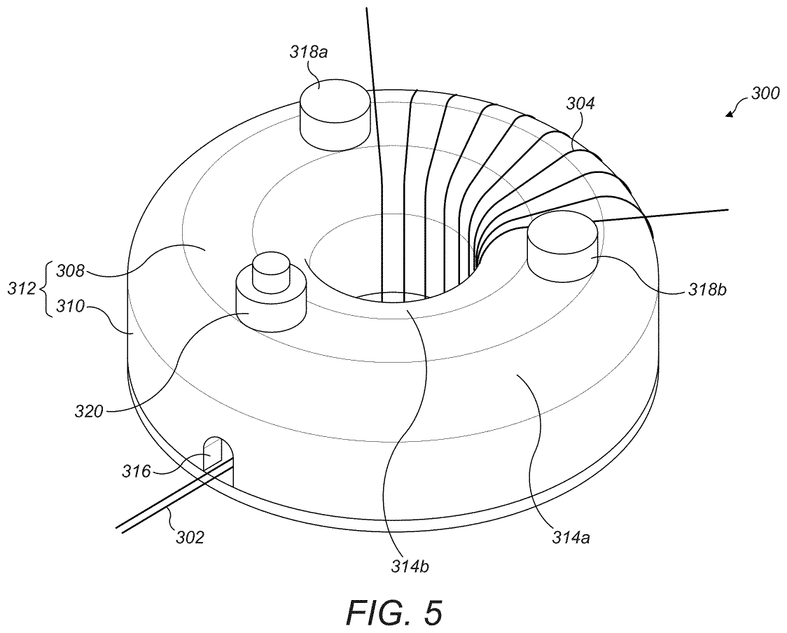

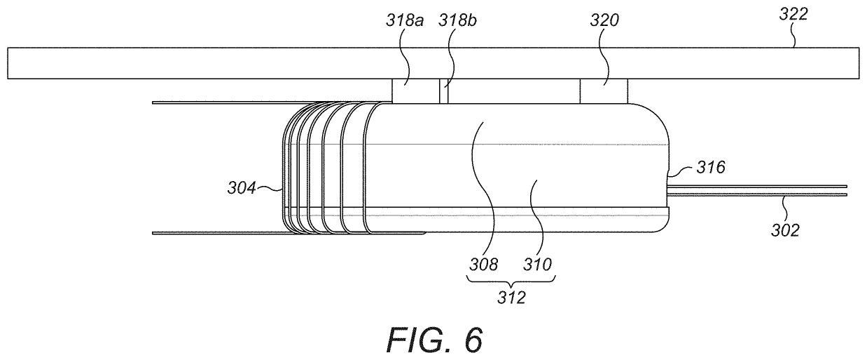

An alternative preferred embodiment of the present invention is described here with reference to FIGS. 5 and 6, which show a diagram of an isolation core casing for a power converter.

Referring firstly to FIG. 5, a transformer 300 includes similar or the same features as those described with reference to FIG. 2. In particular, transformer 300 includes primary winding 302, secondary winding 304, magnetic core (not shown), cover 308 and cup 310 which form core casing 312, joins 314a and 314b, and outlet portion 316. These features are similar or the same as features described previously with reference to FIGS. 2 to 4. The transformer 300 further includes winding alignment standoffs 318a and 318b, and printed circuit board standoff 320.

Winding alignment standoffs 318a and 318b are located on the cover 208 of the core casing 212. The winding alignment standoffs 318a and 318b provide a physical barrier on the cover 308 for the secondary winding 304, such that the secondary winding 304 is wound and contained within the space between the winding alignment standoffs 318a and 318b. The benefit of this is that the secondary winding 304 can be fixed in position relative to the core casing 312, the primary winding 302 and magnetic core. Thus, the relative positions of the secondary winding 304, the primary winding 302 and the magnetic core can be controlled in order to mechanically maintain the required creepage and/or clearance distances between the secondary winding 204 and the primary winding 202. Fixing the positions of the windings in this way also controls the induction properties of the transformer 300. Hence, leakage inductance between windings can be better controlled. Although only the secondary winding 304 is contained by winding alignment standoffs 318a and 318b in FIG. 5, it is to be understood that multiple windings may be contained and separated by their own corresponding winding alignment standoffs. For example, transformer 300 may include a tertiary winding which can be separated from the secondary winding on the cover 308 by more winding alignment standoffs. The winding alignment standoffs 318a and 318b are preferably made of the same insulating material as the cover 308 and cup 310. The winding alignment standoffs 318a and 318b are preferably formed of cylindrical extrusions of plastic, rubber or the like. However, it is to be understood that the shape of the winding alignment standoffs 318a and 318b may be a protrusion of any other three-dimensional shape suitable for preventing the slippage or movement of the secondary winding 304 past a boundary on the cover 308, the boundary being defined by the position of the winding alignment standoffs. The winding alignment standoffs 318a and 318b may form a portion of the cover 308, or alternatively, may be joined to the cover 308 by welding, such as ultrasonic welding, injection welding, laser welding or the like. Additionally, standoffs may be included on the outside of the core cup. Furthermore, winding alignment separators, similar to the standoffs, may be included in the core casing to control and fix the position of the primary winding 302.

The winding alignment standoffs 318a and 318b may provide further functionality for the transformer 300. In particular the winding alignment standoffs 318a and 318b may function as alignment tools for aligning the transformer 300 with a printed circuit board. Furthermore, the winding alignment standoffs 318a and 318b may function as spacers by separating the cover 308 from a mounted printed circuit board. In this case, the height of the winding alignment standoffs 318a and 318b provides a distance of separation between the cover 308 and the printed circuit board. It is to be understood that the primary function of the winding alignment standoffs 318a and 318b may be any one or more of these described functions.

The printed circuit board standoff 320 is an example of a standoff specifically designed for the function of providing and maintaining a separation distance between the cover 308 and a printed circuit board, as discussed above. The printed circuit board standoff 320 is preferably formed of the same material as the cover 308 and is either formed as a portion of the cover 308 or is joined to the cover 308 by welding, such as ultrasonic welding, injection welding, laser welding or the like. The printed circuit board standoff 320 according to FIG. 5 is formed of a larger solid cylinder positioned on the cover 308, with a smaller solid cylinder, or pip, positioned on the top face of the larger cylinder, on the opposite face to the face connected to the cover 308. The purpose of the pip is to be used in alignment with the printed circuit board. The printed circuit board standoff 320 can also perform the functions of the winding alignment standoffs 318a and 318b discussed above.

It is to be understood that the printed circuit board standoff 320 and the winding alignment standoffs 318a and 318b can be implemented according to the preferred embodiments of the present invention as illustrated in FIGS. 2 to 4, and may alternatively or additionally be positioned on the base of the cup 310, or elsewhere on the cover 308 or cup 310 depending on where a printed circuit board or other electrical component is intended to be positioned and/or mounted.

FIG. 6 shows the winding alignment standoffs 318a and 318b and the printed circuit board standoff 320 mounted on a printed circuit board 322. The secondary winding 304 is contained within the winding alignment standoffs 318a and 318b as discussed above. In FIG. 6, the winding alignment standoffs function as spacers between the printed circuit board and the core casing 312 as well as winding alignment standoffs. Potting material may be injected between the printed circuit board and the core casing 212 around the winding alignment standoffs 318a and 318b to fix the secondary winding 302, fix the core casing 312, and/or provide a further level of insulation.

A method of manufacturing and assembling according to a preferred embodiments of the present invention will now be described.

The method of manufacture and assembly optionally starts with forming the cup and cover for the core casing. As described above, the cup and cover are electrical insulators and are preferably within the range of 0.4 mm to 1 mm thick, although these components may be of other thicknesses depending on intended use.

The cup and the cover are formed using conventional techniques. This may include injection moulding, blow moulding, compression moulding, thermoforming, structural foam moulding, three-dimensional printing or the like. The cup and cover are formed to house the magnetic core.

The method further includes the step of winding the primary winding around the magnetic core and housing the magnetic core in the cup. The primary winding is preferably wound directly on the magnetic core. The primary winding is formed of electrically conductive wire. The primary winding may also include insulation in the form of a wire coating or sleeve. However, insulation on the primary winding is not necessary because the magnetic core and the primary winding have the same electrical potential.

Once the primary winding is wound around the magnetic core, the magnetic core is disposed within the cup. Preferably, the cup secures the position of the magnetic core and primary winding, because the cup is a similar size and shape to the magnetic core.

Wiring from the primary winding is then fed out of the cup via the outlet portion, such that it can be connected to external wiring or other circuitry.

The method further includes the step of joining the cup, which houses the magnetic core and primary winding, with the cover to create a sealed core casing. In this step, the cover is positioned to overlay the opening of the cup. Preferably, the cover is joined to the cup around the rims of the opening of the cup using ultrasonic welding. Ultrasonic welding creates a physical, insulating barrier at the join between the cup and cover. This means that the cup and cover are physically sealed, and therefore a creepage and clearance path do not exist from the exterior to the interior of the core casing. This in turns allows smaller components to be used in the manufacture and assembly of the isolation core according to the preferred embodiments of the present invention.

Once the cup and cover are joined and sealed to form the core casing, the method includes the further step of winding the secondary winding around the core casing.

Optionally, the method further includes disposing potting material within the core casing via the outlet portion. Preferably, this involves a void-free potting process, wherein liquid potting material is injected into the interior space of the core casing to fill any available space not taken by the magnetic core and primary winding. Air from within the interior space of the core casing is ejected via the outlet portion. This means that air pockets, dust, or other contaminants are preferably reduced within the interior space of the core casing. The potting material is then allowed to solidify and set. The potting material provides a solid barrier at the outlet portion to seal the outlet portion and insulate the outlet portion. Thus, a clearance and creepage path does not exist through the outlet portion.

Optionally, the method further includes the step of fixing printed circuit board standoffs or winding alignment standoffs to the core casing to either provide a separation distance between the transformer and a printed circuit board, and/or fix the secondary winding in position on the core casing.

When the transformer is in operation, one of the primary or secondary winding is energized and the process of electromagnetic inductance occurs with the magnetic core and the other winding.

Optionally, there may be more than one primary winding disposed within the interior of the core casing and similarly there may be more than one secondary winding disposed on the exterior of the core casing.

It is to be understood that the primary winding and secondary winding may be swapped, such that the secondary winding is disposed within the interior of the core casing, and the primary winding is disposed on the exterior of the core casing.

Described above are a number of preferred embodiments of the present invention with various optional features. It should be appreciated that, with the exception of any mutually exclusive features, any combination of one or more of the optional features are possible. Preferred embodiments of the present invention may take the form of an isolation core casing for a power converter device. The converter device may advantageously be used as a portion of power switching electronic devices, in an AC-DC or DC-DC converter, for example.

What is claimed is:

1. A transformer for a power converter device, the transformer comprising:
a first winding that includes electrically conductive material;
a second winding that includes electrically conductive material;
a core; and
a solid electrical insulator that includes a sealed interior space in which the core and the first winding are housed; wherein
the first winding is wound directly on the core; and
the second winding is wound on an exterior surface of the solid electrical insulator such that the solid electrical insulator provides a physical barrier between the first winding and the second winding.

2. The transformer according to claim 1, wherein
the solid electrical insulator includes at least one protrusion on the exterior surface of the solid electrical insulator, and
the at least one protrusion provides at least one of:
a physical barrier between a circuit board on which the transformer is mounted and the transformer; and
a separation distance between the transformer and the circuit board.

3. The transformer according to claim 2, wherein the at least one protrusion performs at least one of:
securing a position of the second winding exterior to the solid electrical insulator; and
connecting to the circuit board.

4. The transformer according to claim 1, wherein
a shape of the solid electrical insulator corresponds to a shape of the core; and
the solid electrical insulator receives and houses the core and the first winding within the sealed interior space of the solid electrical insulator.

5. The transformer according to claim 1, wherein
a thickness of the solid electrical insulator is within a range of 0.4 mm to 1 mm,
the thickness is defined as a distance from the exterior surface of the solid electrical insulator to a nearest point on an interior surface of the solid electrical insulator, and
the interior surface of the solid electrical insulator defines the sealed interior space of the solid electrical insulator.

6. The transformer according to claim 1, wherein
the solid electrical insulator includes at least two separate portions, and
the at least two separate portions being joined and sealed together to define the solid electrical insulator including the sealed interior space of the solid electrical insulator.

7. The transformer according to claim 6, wherein the at least two separate portions are joined and sealed by an ultrasonically welded portion.

8. The transformer according to claim 6, wherein
the at least two separate portions include a cup and a cover;
the cup includes:
at least one surface wall that defines the sealed interior space of the solid electrical insulator; and
a first opening; and
the cover includes at least one surface wall overlaying the first opening of the cup.

9. The transformer according to claim 8, wherein
a shape of the cup is defined by an inner tube and an outer tube,
the inner and the outer tubes are arranged as two concentric substantially cylindrical tubes,
the inner tube being joined to the outer tube by an annular surface that joins an outside circumference of the inner tube with an inside circumference of the outer tube, at a corresponding end of the inner and the outer tubes,
the first opening of the cup is located at opposing ends of the inner and outer tubes in an absence of a second annular surface; and
shape of the cover is an annular surface configured to fit the first opening of the cup.

10. The transformer according to claim 1, wherein
the solid electrical insulator further includes a second opening that connects the exterior surface of the solid electrical insulator with the sealed interior space of the solid electrical insulator; and
the second opening receives potting material to the sealed interior space of the solid electrical insulator and allows air to travel from the sealed interior space of the solid electrical insulator to the exterior surface of the solid electrical insulator.

11. The transformer according to claim 10, wherein the first winding is fed through the second opening.

12. The transformer according claim 10, further comprising potting material disposed within the sealed interior space of the solid electrical insulator.

13. The transformer according to claim 12, wherein the second opening is sealed by the potting material.

14. The transformer according to claim 1, wherein the core is magnetic.

15. The transformer according to claim 1, wherein the core is toroidal.

16. The transformer according to claim 1, wherein the power converter device is an AC-DC converter or a DC-DC converter.

17. The transformer according to claim 1, further comprising at least one additional winding wound directly on the core and housed within the solid electrical insulator.

18. The transformer according to claim 1, further comprising at least one additional winding wound on the exterior surface of the solid electrical insulator.

19. The transformer according to claim 1, wherein the first winding is a primary winding, and the second winding is a secondary winding.

20. The transformer according to claim 18, wherein the first winding is a secondary winding, and the second winding is a primary winding.

21. A method of manufacturing or assembling a transformer; the method comprising:
winding a first winding of electrically conductive material directly around a core;
positioning and housing the core within an interior space of a sealed solid electrical insulator; and
winding a second winding of electrically conductive material around an exterior surface of the sealed solid electrical insulator; wherein
the first winding is electrically insulated from the secondary winding by a physical barrier provided by the sealed solid electrical insulator.

22. The method of claim 21, further comprising sealing the sealed solid electrical insulator using ultrasonic welding.

23. The method of claim 21, further comprising disposing potting material in the interior space of the sealed solid electrical insulator after the positioning and housing the core within the interior space of the sealed solid electrical insulator.

24. The method of claim 21, wherein
the sealed solid electrical insulator includes at least one protrusion on the exterior surface of the sealed solid electrical insulator, and
the at least one protrusion provides at least one of:
a physical barrier between a circuit board on which the transformer is mounted and the transformer; and
a separation distance between the transformer and the circuit board.

25. The method of claim 24, wherein the at least one protrusion performs at least one of:
securing a position of the second winding exterior to the sealed solid electrical insulator; and
connecting to the circuit board.
